(19) United States
(12) Patent Application Publication
(10) Pub. No.: US 2017/0220206 A1
(43) Pub. Date: Aug. 3, 2017

(54) CONTENT SUGGESTIONS IN A PRESENTATION PROGRAM

(71) Applicant: Microsoft Technology Licensing, LLC, Redmond, WA (US)

(72) Inventors: Stephanie L. Horn, Bellevue, WA (US); Virag Shah, Hyderabad (IN); Gajendra Agrawal, Hyderabad (IN)

(21) Appl. No.: 15/242,253

(22) Filed: Aug. 19, 2016

(30) Foreign Application Priority Data
Feb. 2, 2016 (IN) 201641003646

(51) Int. Cl. G06F 3/0482; G06F 3/0488; G06F 17/30; G06F 3/0486

(52) U.S. Cl. CPC G06F 3/0482; G06F 3/0486; G06F 3/04883; G06F 17/30867

(57) ABSTRACT

A productivity application is disclosed herein that includes an insert-content feature in a user interface to the productivity application. When the insert-content feature is selected to insert online content into a canvas, the application initiates an online search using text in the canvas. Results that are returned from the search may be presented in a panel adjacent to the canvas.

### TECHNICAL BACKGROUND

Presentation programs are software applications that allow end-users to create slide-based presentations. PowerPoint® from Microsoft®, and Google® Slides, and Keynote® from Apple® are several examples of presentation programs that follow the slide-show model for presentations. Such programs are frequently provided in the context of a productivity software suite that includes other applications, such as word processing and spreadsheet applications, although stand-alone presentation programs are available.

Three basic components are usually present in the user interface to most presentation programs. A feature menu allows a user to add slides to his or her presentation, and then to interact with a given slide via a wide variety of features, functions, and tools. A preview panel displays a preview of all of the slides in a given presentation, which allows a user to navigate backward and forward in the presentation, add and delete slides, and reorder them. When a given slide is selected in the panel, its content is displayed on a full-size canvas and the end-user may edit the slide in the canvas.

Two basic modes are supported in presentation programs: an editing mode and a presentation mode. The feature menu, the side panel, and the canvas are rendered when in the editing mode, but typically are absent when in the presentation mode. Rather, the presentation mode provides a clean view of a presentation for consumption by an audience.

Among the many tools available in a presentation program, an insert tool allows various types of content to be easily inserted into a slide, such as tables, pictures, charts, and online pictures. To insert online pictures, a user may first navigate to an insert feature menu, from where an online pictures sub-feature is selected. Selecting the sub-feature may result in a search interface displayed over a slide's canvas that allows the user to enter specific text that can be submitted to a search engine. Images returned from the search engine may be selected and inserted into the slide.

From a usability perspective, such a tool is helpful but can be cumbersome to work with. For example, the search interface may occupy the top level above a canvas in a view hierarchy (obstructing a view of the canvas) and must be exited in order to return to the canvas. In addition, the user must enter the text to be searched by the search engine. From a more technical perspective, such a design may add steps to the design flow, which in the aggregate can waste device resources, such as processing cycles, display resources, and battery life.

### OVERVIEW

Technology is disclosed herein that enhances the user experience with presentation programs and various operational aspects of such programs. Such technology may be applied as well in the content of any productivity application, such as word processing applications, spreadsheet applications, or note taking applications.

In an implementation, a presentation program renders a presentation slide in a user interface to the presentation program with an insert-content feature present in the user interface. In response to when the insert-content feature is selected to insert online content into the presentation slide, the presentation program initiates an online search using text present in the presentation slide. The presentation program receives results of the online search and responsively identifies categories in which to present the results in a view associated with the insert-content feature. The presentation program then presents the view associated with the insert-content feature in the user interface with the categories in the view.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIGS. 1A-1D illustrate an operational scenario in an implementation of online content insertion in a presentation program.

FIG. 2 illustrates a process employed by a presentation program in an implementation.

FIGS. 3A-3I illustrate an operational scenario in an implementation of online content insertion in a presentation program.

FIG. 4 illustrates a computing system suitable for implementing the enhanced presentation technology disclosed herein, including any of the architectures, elements, processes, and operational scenarios and sequences illustrated in the Figures and discussed below in the Technical Disclosure.

### TECHNICAL DISCLOSURE

Technology is disclosed herein for enhancing the digital presentation creation experience. In an implementation, an online content tool is available that allows a user to quickly and easily find and insert online content into a presentation document (such as images, icons, and video). Suggestions may be surfaced that are based on the content of the slides in the presentation. Such technology may be applicable to other types of documents in addition to presentations, such as word processing documents, spreadsheets, and the like.

The suggestions may be dynamically changed based on new content that is added to a slide(s). Suggestions may vary based on the application context. For example, suggestions made in a presentation application may be predominantly images, whereas the suggestions surfaced in a word processing application may include more text.

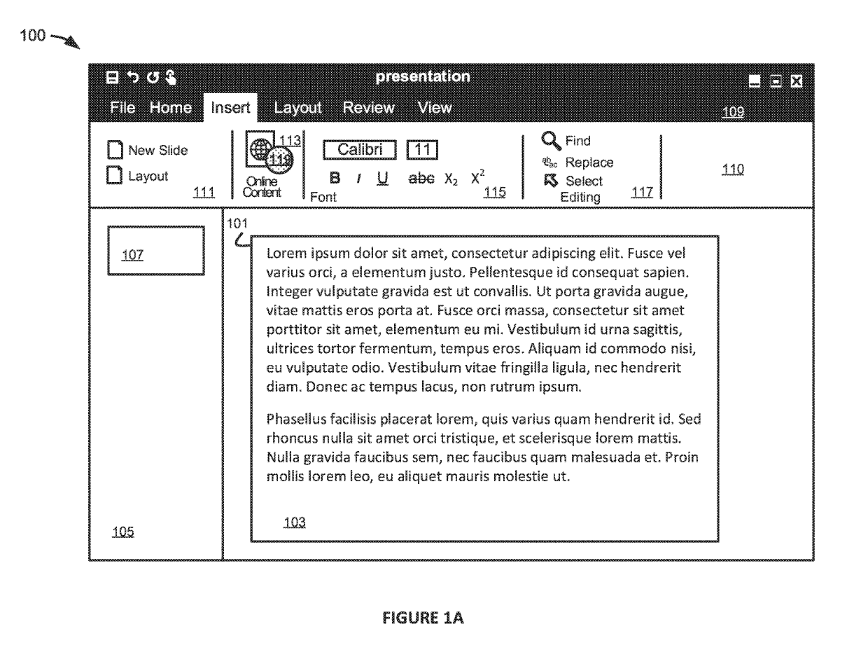

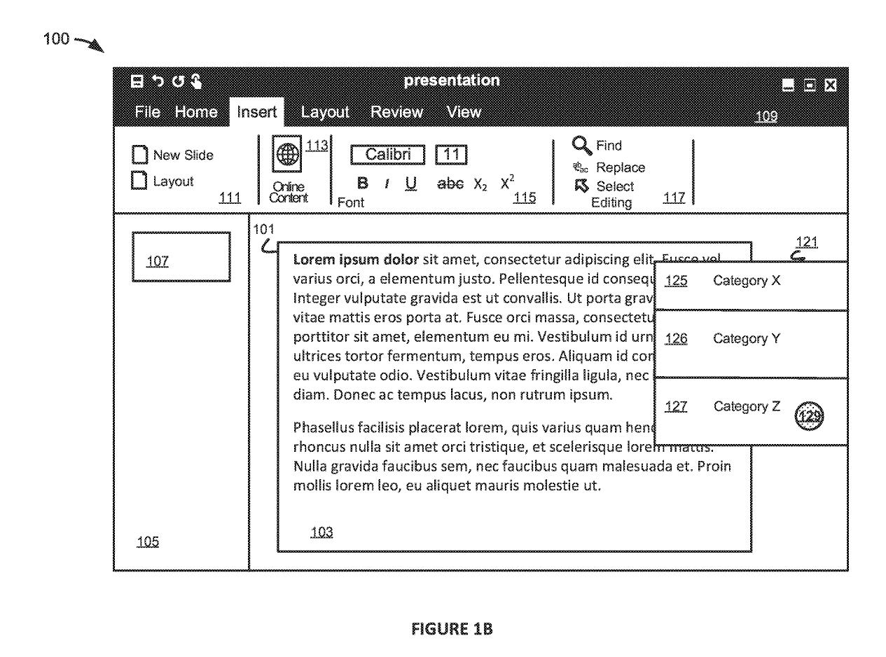

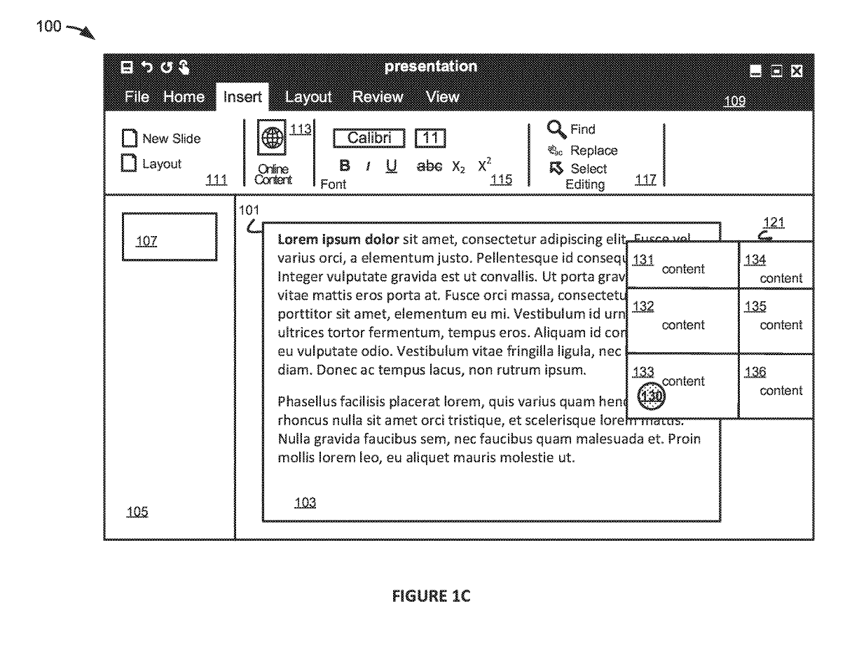

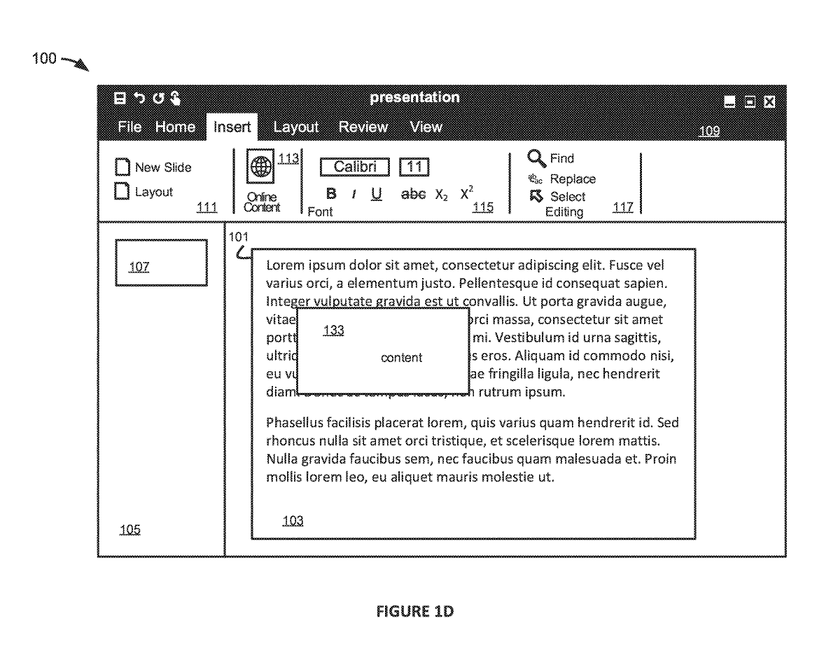

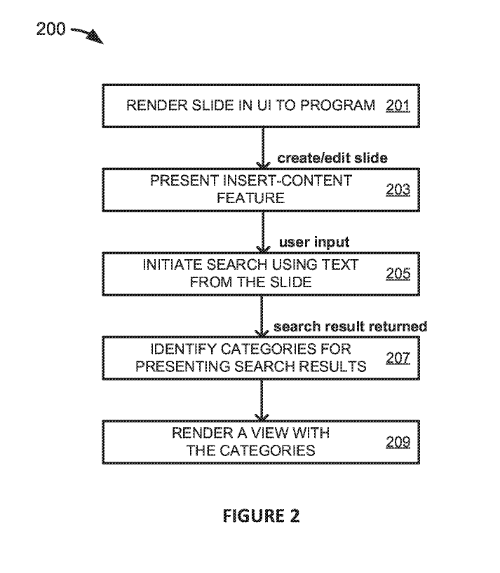

FIGS. 1A-1D illustrate a scenario in the operation of a presentation application when employing process 200, illustrated in FIG. 2. Process 200 may be implemented in one or more software components, modules, or other such logical constructs that execute in the context of the presentation application.

Referring briefly to the steps illustrated in FIG. 2, the presentation application renders a presentation slide in a user interface to the presentation program (step 201). A user may edit the slide by adding text, images, clips, or any other type of content. An insert online content feature may then be presented by the application in the user interface when a user navigates to a particular menu, view, or other portion of the user interface that includes the feature (step 203).

If the feature is selected by way of user input, the presentation application initiates on online search for content to insert into the slide using text from the slide (step 205). Search results are returned, which the presentation application examines to identify categories for presenting the results (step 207). A view is then rendered in the user interface that includes the categories (step 209). The user may select one of the categories in order to further explore possible content for inserting into the slide.

Referring back to FIGS. 1A-1D, the operational scenario illustrated therein is representative of one implementation of process 200 in the context of a user interacting with a presentation application to insert online content into a presentation slide.

User interface 100 in FIG. 1A includes a slide 101 on which a user may create presentation content, such as by adding text, images, or the like to canvas 103. A preview panel 105 provides a brief thumbnail preview of the slides in a presentation deck. To begin, only preview 107 corresponding to slide 101 is in preview panel 105.

User interface 100 also includes a menu 109 from which to select various feature menus, including a file, home, insert, layout, review, and view menus. In this scenario, insert menu 110 has been selected. Insert menu 110 includes various feature sets 111, 113, 115, and 117. Feature set 113, includes an insert online content feature that, when selected by user input 119, allows a user to insert images, text, video, clips, or any other suitable content from an online source into slide 101. Examples of user input 119 include, but are not limited to, a touch, mouse click, spoken command, or any other user input.

In response to the user selecting the insert online content feature, the presentation program selects text from slide 101 with which to query an online service for content. The search results are then categorized and displayed in a view in user interface 100. FIG. 1B illustrates the transition that occurs in the user interface 100. View 121 includes various categories (category 125, category 126, and category 127). The user may then make a selection of any of the categories to further explore the content in that category. User input 129 represents a selection of category 127, which transitions view 121 to a state that includes specific content items in category 127.

Referring to FIG. 1C, category 127 (selected in FIG. 1B) is shown as including content retrieved by the search, represented by items 131, 132, 133, 134, 135, and 136. The content may include, for example, images, clips, text, or other such content that the user may want to select for inclusion into slide 101. The user via user input 130 makes a selection of item 133 which, as illustrated in FIG. 1D, results in item 133 being included in slide 101. In this example, item 133 is deposited over the text on canvas 103, although many other options are possible for including an image or clip in slide content.

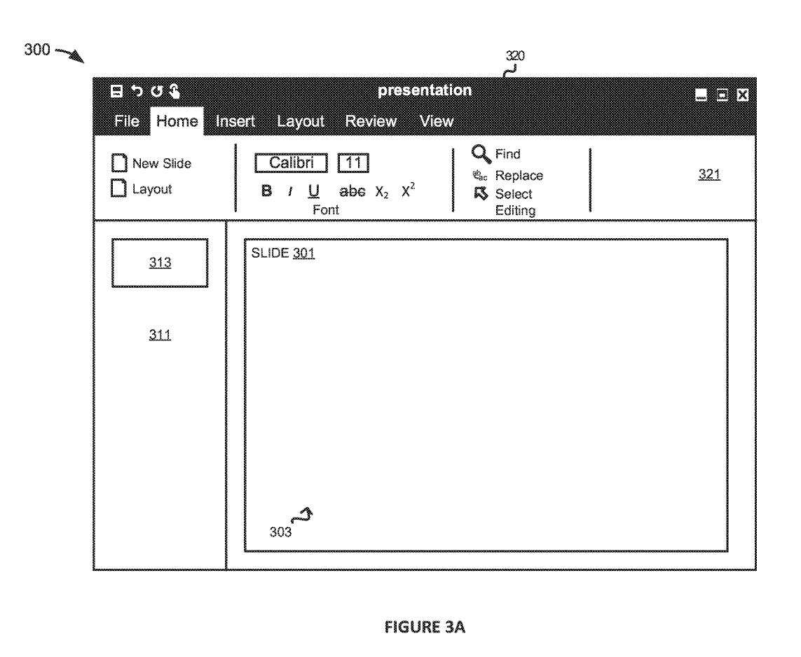

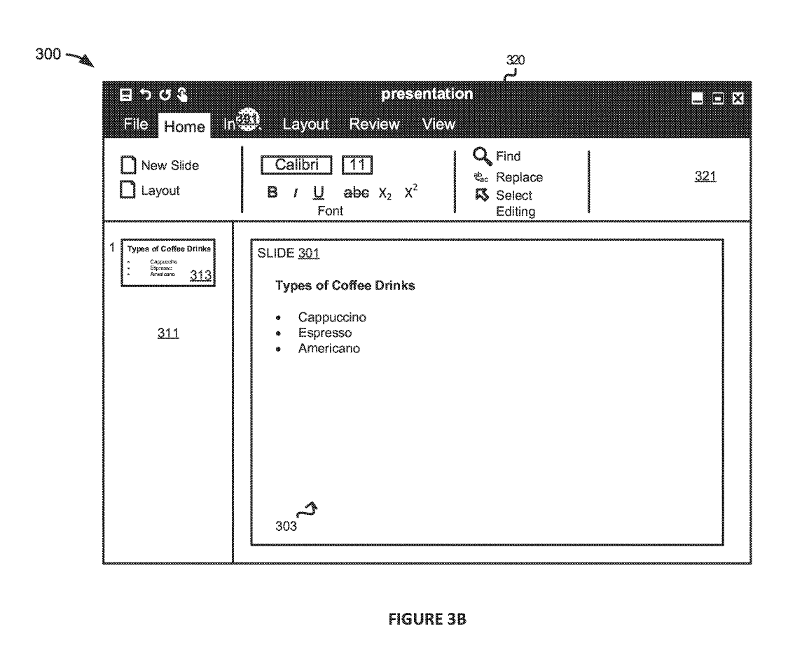

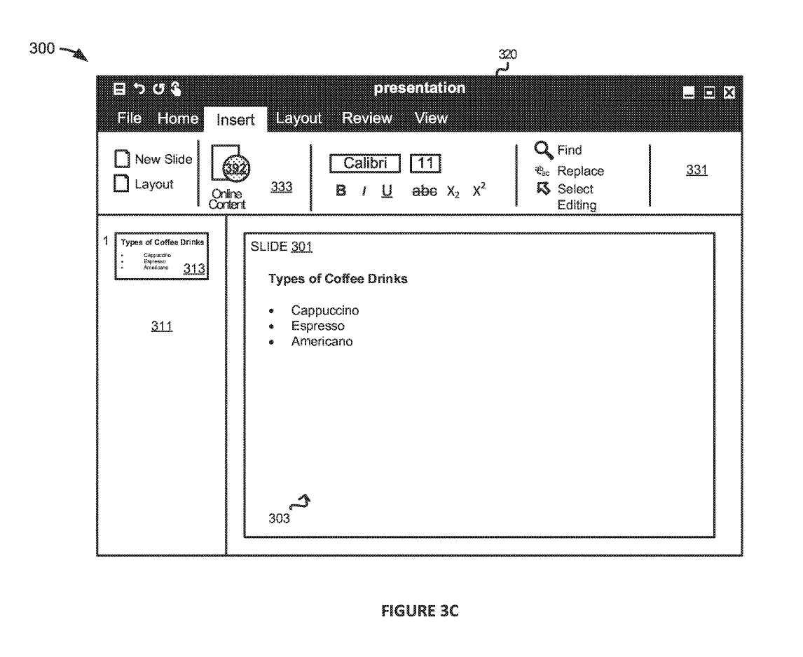

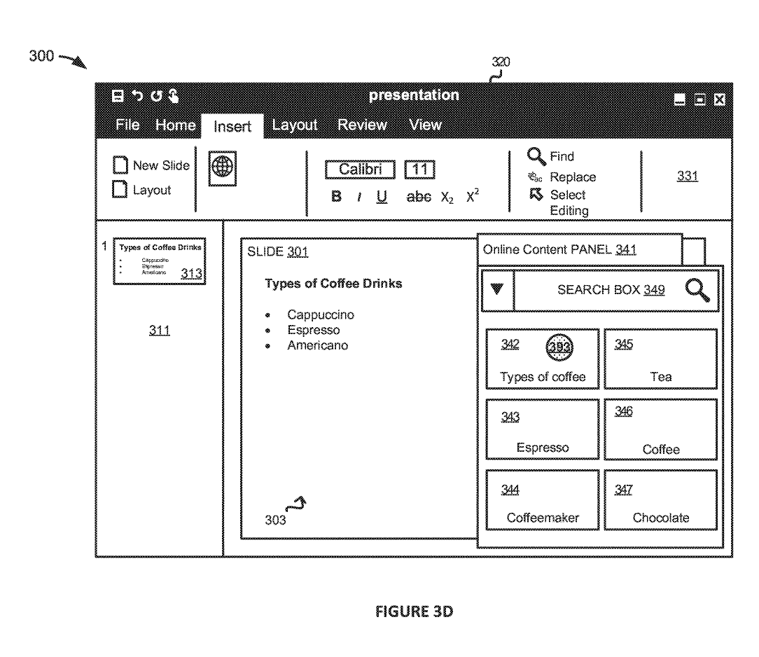

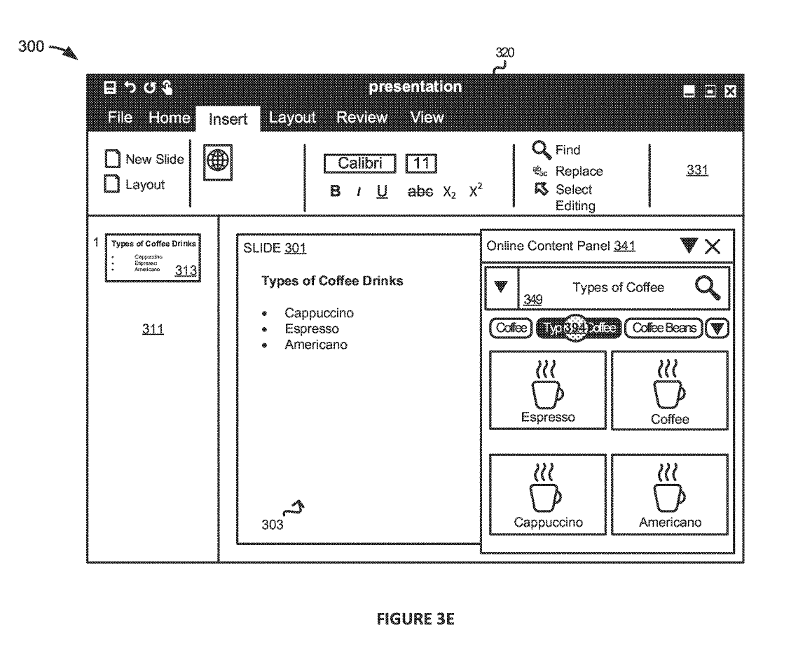

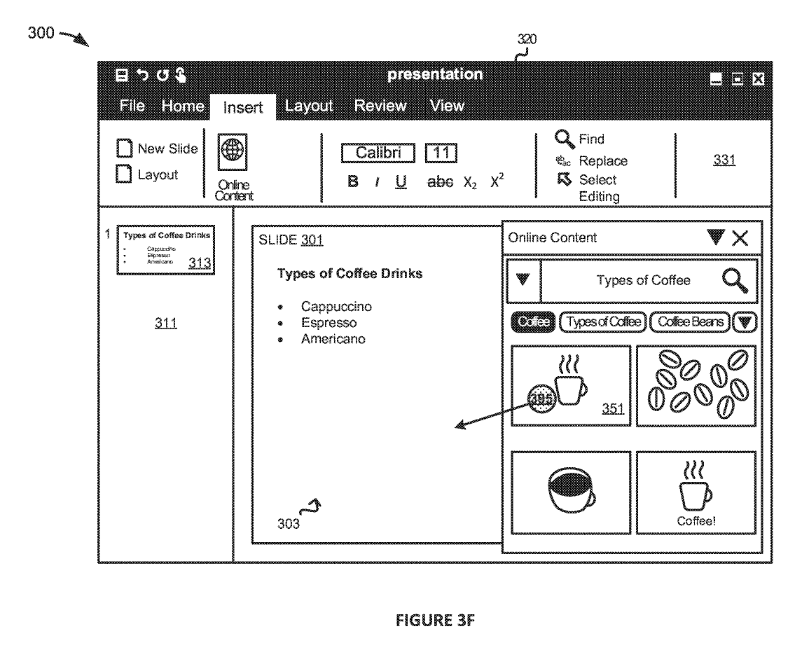

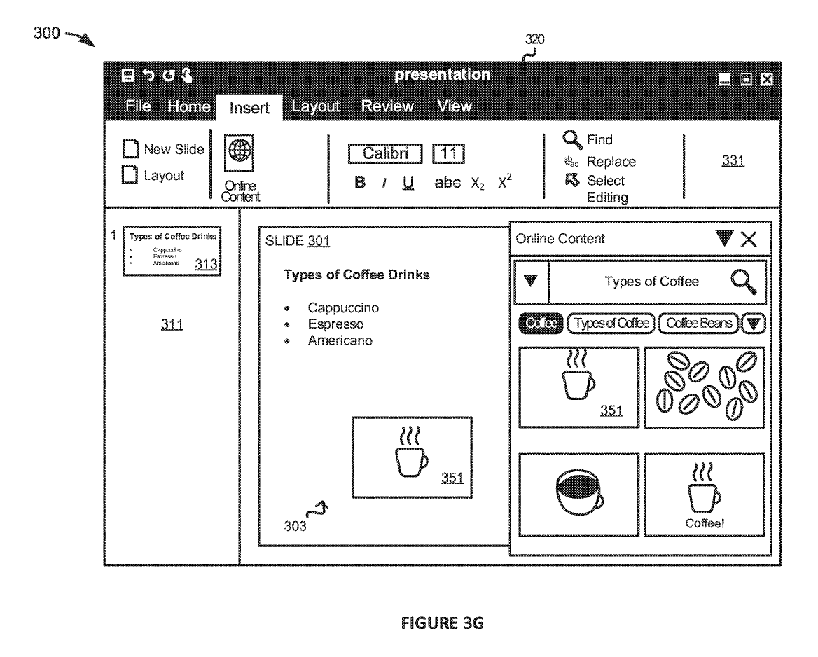

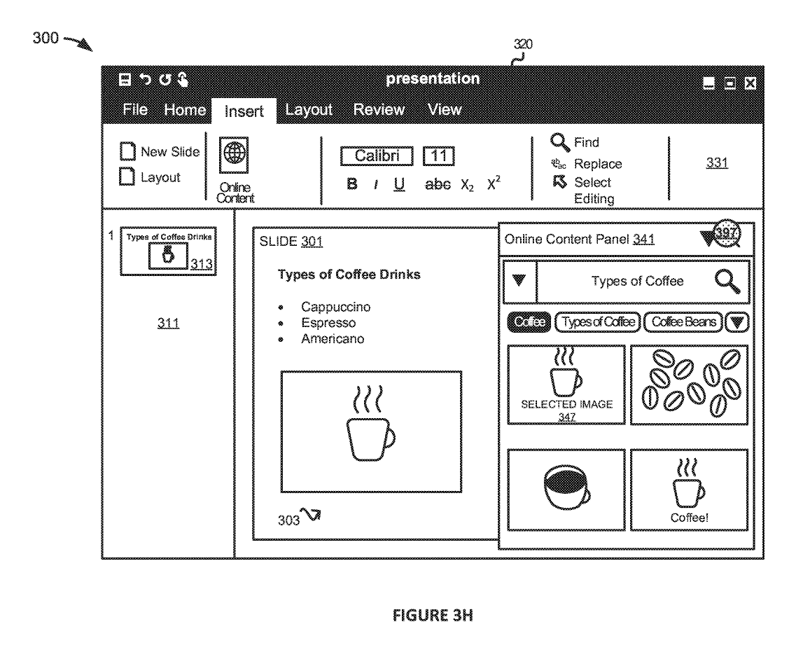

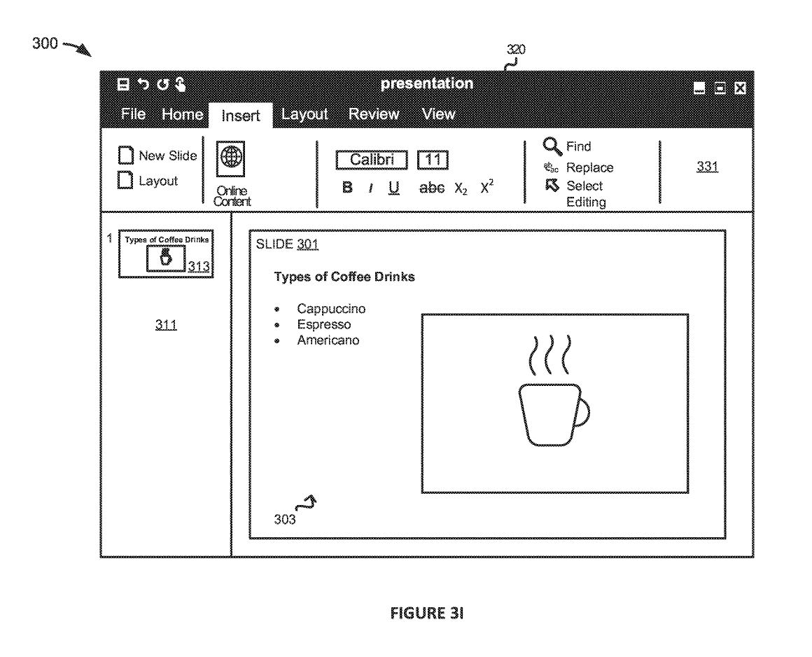

In another implementation, FIGS. 3A-3I illustrate a user interface to a presentation program as the user interface transitions through various states in response to user inputs. The various states illustrated in the drawings represent the new features and functionality proposed herein to enhance presentation technology.

In FIG. 3A, user interface 300 includes a slide 301. The slide 301 includes a canvas 303 onto which a user may deposit text, images, and other suitable content in the context of developing a digital slide presentation. Preview panel 311 includes a previews 313 of slide 301. As more slides are added to the presentation, more previews are rendered in preview panel 311.

User interface 300 also includes a feature menu 320 with sub-menus that house various features and tools for interacting with a presentation. For example, feature menu 321 includes the home, insert, design, transitions, animations, slide show, review, and view sub-menus. When a given sub-menu is selected, its options and elements are displayed in a ribbon tool bar. The tools presented in the ribbon tool bar represent the various features and functionality associated with the sub-menu. In this example, the home sub-menu is selected, which surfaces various home tools, such as the paste, new slide, and arrange tools.

In FIG. 3B, the user interface 300 has progressed to included content input by a user in the form of text strings. In addition, a user input 391 is illustrated that represents a selection of a different sub-menu, the “insert” sub-menu. Examples of user input 391 and any other user input discussed herein include, but are not limited to, a touch, a gesture, a mouse click, a spoken command, or any other suitable user input.

When the insert sub-menu 331 is selected, the ribbon tool bar transitions to a set of tools associated with the insert sub-menu 331, illustrated in FIG. 3C. The insert sub-menu 331 includes various tools related to inserting content, such as table tool for inserting a table, a photo album tool for inserting photos, and a chart tool for inserting a chart.

The insert sub-menu 331 also includes a new tool for inserting online content. The online content tool 333, when selected, allows a user to more easily consider, consume, and ultimately insert content that is found online.

In this example, user input 392 is received which represents a selection of the online content tool. The selection triggers a transition in the user interface 300 to a state illustrated in FIG. 3D. When the online content tool is selected, an online content panel 341 is displayed adjacent to canvas 303.

The presentation program automatically populates the online content panel 341 with the suggested categories 342, 343, 344, 345, 346, 347 when the online content tool is selected. The categories are identified by the presentation program by first performing a background search using keywords found in one or more slides of the presentation. The presentation program analyzes the search results to identify words in the results that occur in such a manner that they may be considered categories. For example, an online search for the keywords coffee, drinks, cappuccino, espresso, and Americano returns a large volume of results. The results can be analyzed to identify a broad set of categories that the results may fall into. A variety of ways to identify categories are possible and may be considered within the scope of the disclosure.

The categories may then be presented in a visual manner in online content panel 341. When a user selects one of the categories, the category is entered into search box 349 and a further search is performed using the category as a refiner. For example, in FIG. 3D, user input 393 is received selecting the “types of coffee” category. User interface 300 transitions to another state illustrated in FIG. 3E. When a given category is selected (e.g. types of coffee), more specific results are returned and are presented in online content panel 341. The user can select an image or images from the results to deposit onto canvas 303. In addition, the suggested categories are no longer arranged as in FIG. 3D, but rather are rearranged into a list presented above the search results.

Selecting another category changes the search results. For example, user input 394 is received and is representative of a selection of the coffee category. In response, the user interface 300 transitions to include search results for the string “coffee,” which is illustrated in FIG. 3F. The user may select one or more images for inclusion in slide 301, such as by dragging and dropping an image 351, as represented by user input 395 in FIG. 3F. In FIG. 3G, the image 351 is deposited onto canvas 303 and may be moved around, resized, and so on. In FIG. 3H, the image 351 has been enlarged. Assuming the user is satisfied and desires to close the online content panel 341, a user input 397 is received to close the panel and the user interface 300 returns to its initial state (FIG. 31).

Various technical effects may be appreciated with respect to the presentation and productivity features disclosed herein. For example, automatically initiating an online search using text in a slide eliminates the step of a user entering a search string. In another example, identifying and presenting search results in categories may reduce the number of steps involved in finding and selecting a desired content item to insert into a slide. In the aggregate, such a streamlined design flow may conserve device resources, such as processing cycles, display resources, and battery life.

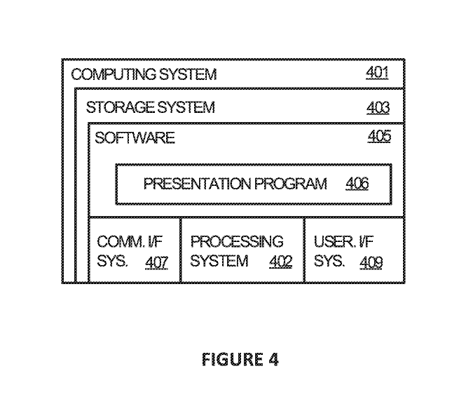

FIG. 4 illustrates computing system 401 that is representative of any system or collection of systems in which the various applications, services, scenarios, and processes disclosed herein may be implemented. Examples of computing system 401 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 401 may be implemented as a single apparatus, system, or device or may be implemented in a distributed manner as multiple apparatuses, systems, or devices. Computing system 401 includes, but is not limited to, processing system 402, storage system 403, software 405, communication interface system 407, and user interface system 409. Processing system 402 is operatively coupled with storage system 403, communication interface system 407, and user interface system 409.

Processing system 402 loads and executes software 405 from storage system 403. Software 405 includes presentation program 406, which is representative of the program(s) discussed with respect to the preceding Figures. When executed by processing system 402 to enhance document presentations, software 405 directs processing system 402 to operate as described herein for at least the various processes, operational scenarios, and sequences discussed in the foregoing implementations. Computing system 401 may optionally include additional devices, features, or functionality not discussed for purposes of brevity.

Referring still to FIG. 4, processing system 402 may comprise a micro-processor and other circuitry that retrieves and executes software 405 from storage system 403. Processing system 402 may be implemented within a single processing device, but may also be distributed across multiple processing devices or sub-systems that cooperate in executing program instructions. Examples of processing system 402 include general purpose central processing units, application specific processors, and logic devices, as well as any other type of processing device, combinations, or variations thereof.

Storage system 403 may comprise any computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device, but may also be implemented across multiple storage devices or sub-systems co-located or distributed relative to each other. Storage system 403 may comprise additional elements, such as a controller, capable of communicating with processing system 402 or possibly other systems.

Software 405 may be implemented in program instructions and among other functions may, when executed by processing system 402, direct processing system 402 to operate as described with respect to the various operational scenarios, sequences, and processes illustrated herein. For example, software 405 may include program instructions for implementing state transitions in a user interface to a presentation program.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtual machine software, or other application software, in addition to or that include presentation program 406. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system customized to facilitate enhanced presentation creation and editing. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 409 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here.

User interface system 409 may also include associated user interface software executable by processing system 402 in support of the various user input and output devices discussed above. Separately or in conjunction with each other and other hardware and software elements, the user interface software and user interface devices may support a graphical user interface, a natural user interface, or any other type of user interface to present a user interface to a presentation program as discussed herein, such as user interface 100, user interface 300, or any other user interface to a productivity application.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTMLS, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

Example 1. A computing apparatus comprising: one or more computer readable storage media; a processing system operatively coupled with the one or more computer readable storage media; and a presentation program comprising program instructions stored on the one or more computer readable storage media that, when read and executed by the processing system, direct the processing system to at least: render a presentation slide in a user interface to the presentation program; present an insert-content feature in the user interface; when the insert-content feature is selected to insert online content into the presentation slide, initiate an online search using text present in the presentation slide; receive results of the online search and identify categories in which to present the results in a view associated with the insert-content feature; and present the view associated with the insert-content feature in the user interface with the categories in the view.

Example 2. The computing apparatus of claim 1 wherein the program instructions further direct the processing system to: render a partial preview of at least a smart art graphic that is customized based on content in a presentation slide; in response to selecting the partial preview, transition the partial preview to a full preview of the smart art graphic; and in response to selecting the smart art graphic, present the smart art graphic in the presentation slide.

Example 3. The computing apparatus of Example 1-2 wherein, in response to a selection of a category from the categories, the program instructions direct the processing system to present a subset of the results associated with the category in the view.

Example 4. The computing apparatus of Examples 1-3 wherein, in response to the selection of the category from the categories, the program instructions direct the processing system to present others of the categories along with the subset of the results in the view.

Example 5. The computing apparatus of Examples 1-4 wherein the results comprise images returned by an online search engine and wherein the view associated with the slide comprises a panel positioned adjacent to the presentation slide.

Example 6. The computing apparatus of Examples 1-5 wherein the program instructions direct the processing system to select at least a portion of the text in the presentation slide to use as input to an online search engine that performs the online search.

Example 7. The computing apparatus of Examples 1-6 wherein, to initiate the online search using the text in the slide, the program instructions direct the processing system to query the online search engine with at least the portion of the text, and wherein the program instructions, in response to a selection of one of the categories, direct the processing system to query the online search engine with a description of the one of the categories.

Example 8. One or more computer readable storage media having a presentation program stored thereon comprising program instructions that, when read and executed by a processing system, direct the processing system to at least: render a presentation slide in a user interface to the presentation program; present an insert-content feature in the user interface; when the insert-content feature is selected to insert online content into the presentation slide, initiate an online search using text present in the presentation slide; receive results of the online search and identify categories in which to present the results in a view associated with the insert-content feature; and present the view associated with the insert-content feature in the user interface with the categories in the view.

Example 9. The one or more computer readable storage media of Example 8 wherein, in response to a selection of a category from the categories, the program instructions direct the processing system to present a subset of the results associated with the category in the view.

Example 10. The one or more computer readable storage media of Examples 8-9 wherein, in response to the selection of the category from the categories, the program instructions direct the processing system to present others of the categories along with the subset of the results in the view.

Example 11. The one or more computer readable storage media of Examples 8-10 wherein the results comprise images returned by an online search engine and wherein the view associated with the slide comprises a panel positioned adjacent to the presentation slide.

Example 12. The one or more computer readable storage media of Examples 8-11 wherein the program instructions direct the processing system to select at least a portion of the text in the presentation slide to use as input to an online search engine that performs the online search.

Example 13. The one or more computer readable storage media of Examples 8-12 wherein to initiate the online search using the text in the slide, the program instructions direct the processing system to query the online search engine with at least the portion of the text.

Example 14. The one or more computer readable storage media of Examples 8-13 wherein the program instructions, in response to a selection of one of the categories, direct the processing system to query the online search engine with a description of the one of the categories.

Example 15. A method of operating a computing system having a productivity application executing thereon, the method comprising: rendering a presentation canvas in a user interface to the productivity application; present an insert-content feature in the user interface; when the insert-content feature is selected to insert online content into the presentation canvas, initiate an online search using text present in the presentation canvas; receive results of the online search and identify categories in which to present the results in a view associated with the insert-content feature; and present the view associated with the insert-content feature in the user interface with the categories in the view.

Example 16. The method of Example 15 wherein, in response to a selection of a category from the categories, the program instructions direct the processing system to present a subset of the results associated with the category in the view.

Example 17. The method of Examples 15-16 wherein, in response to the selection of the category from the categories, the program instructions direct the processing system to present others of the categories along with the subset of the results in the view.

Example 18. The method of Examples 15-17 wherein the results comprise images returned by an online search engine and wherein the view associated with the slide comprises a panel positioned adjacent to the presentation canvas.

Example 19. The method of Examples 15-18 wherein the program instructions direct the processing system to select at least a portion of the text in the presentation slide to use as input to an online search engine that performs the online search.

Example 20. The method of Examples 15-19 wherein to initiate the online search using the text in the slide, the program instructions direct the processing system to query the online search engine with at least the portion of the text.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
a productivity application comprising program instructions stored on the one or more computer readable storage media that, when read and executed by the processing system, direct the processing system to at least:
render a presentation canvas in a user interface to the productivity application;
present an insert-content feature in the user interface;
when the insert-content feature is selected to insert online content into the presentation canvas, initiate an online search using text present in the presentation canvas;
receive results of the online search and identify categories in which to present the results in a view associated with the insert-content feature; and
present the view associated with the insert-content feature in the user interface with the categories in the view.

2. The computing apparatus of claim 1 wherein the productivity application comprises a presentation program.

3. The computing apparatus of claim 2 wherein the presentation canvas comprises a presentation slide.

4. The computing apparatus of claim 3 wherein, in response to a selection of a category from the categories, the program instructions direct the processing system to present a subset of the results associated with the category in the view.

5. The computing apparatus of claim 4 wherein, in response to the selection of the category from the categories, the program instructions direct the processing system to present others of the categories along with the subset of the results in the view.

6. The computing apparatus of claim 5 wherein the results comprise images returned by an online search engine and wherein the view associated with the presentation slide comprises a panel positioned adjacent to the presentation slide.

7. The computing apparatus of claim 6 wherein the program instructions direct the processing system to select at least a portion of the text in the presentation slide to use as input to an online search engine that performs the online search.

8. The computing apparatus of claim 7 wherein to initiate the online search using the text in the presentation slide, the program instructions direct the processing system to query the online search engine with at least the portion of the text.

9. A method of operating a computing system having a productivity application executing thereon, the method comprising:
rendering a presentation canvas in a user interface to the productivity application;
present an insert-content feature in the user interface;
when the insert-content feature is selected to insert online content into the presentation canvas, initiate an online search using text present in the presentation canvas;
receive results of the online search and identify categories in which to present the results in a view associated with the insert-content feature; and
present the view associated with the insert-content feature in the user interface with the categories in the view.

10. The method of claim 9 further comprising, in response to a selection of a category from the categories, presenting a subset of the results associated with the category in the view.

11. The method of claim 10 further comprising, in response to the selection of the category from the categories, presenting others of the categories along with the subset of the results in the view.

12. The method of claim 11 wherein the results comprise images returned by an online search engine and wherein the view associated with the slide comprises a panel positioned adjacent to the presentation canvas.

13. The method of claim 12 further comprising selecting at least a portion of the text in the presentation canvas to use as input to an online search engine that performs the online search.

14. The method of claim 13 further comprising querying the online search engine with at least the portion of the text.

15. The method of claim 14 wherein the productivity application comprises a presentation program and wherein the presentation canvas comprises a presentation slide.

16. One or more computer readable storage media having a presentation program stored therein comprising program instructions that, when executed by a processing system, direct the processing system to at least:
render a presentation slide in a user interface to the presentation program;
present an insert-content feature in the user interface;
when the insert-content feature is selected to insert online content into the presentation slide, initiate an online search using text present in the presentation slide;
receive results of the online search and identify categories in which to present the results in a view associated with the insert-content feature; and
present the view associated with the insert-content feature in the user interface with the categories in the view.

17. The one or more computer readable storage media of claim 16 wherein, in response to a selection of a category from the categories, the program instructions direct the processing system to present a subset of the results associated with the category in the view.

18. The one or more computer readable storage media of claim 17 wherein, in response to the selection of the category from the categories, the program instructions direct the processing system to present others of the categories along with the subset of the results in the view.

19. The one or more computer readable storage media of claim 18 wherein the results comprise images returned by an online search engine and wherein the view associated with the presentation slide comprises a panel positioned adjacent to the presentation slide.

20. The computing apparatus of claim 6 wherein the program instructions direct the processing system to select at least a portion of the text in the presentation slide to use as input to an online search engine that performs the online search.
